(19) United States
(12) Patent Application Publication
(10) Pub. No.: US 2003/0074290 A1
(43) Pub. Date: Apr. 17, 2003

(54) Methods, systems and articles of manufacture for managing delinquent financial accounts

(75) Inventor: Lisa Dowdy Clore, Glen Allen, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/241,581

(22) Filed: Sep. 12, 2002

Related U.S. Application Data
(60) Provisional application No. 60/329,528, filed on Oct. 17, 2001.

(51) Int. Cl. G06F 17/60

(52) U.S. Cl. 705/35

(57) ABSTRACT

Methods, systems, and articles of manufacture are disclosed for providing a repayment plan to financial account customers, such as credit card customers. Customers may be offered membership into a repayment plan provided by a financial account provider to allow the customers to pay back debt associated with their credit card accounts. A customer may select one of several options associated with the plan that have various parameters, such as different payment amounts, due dates, and/or fees. The financial account provider may offer incentives to customers to make timely payments while a member of the repayment plan, such as adjustments to a credit bureau report upon successful completion of the plan. The financial account provider may also be configured to monitor the activity of a customer's account during the repayment plan to ensure the customer meets determined criteria associated with the repayment plan option selected by the customer. If the customer fails to meet this criteria, their account may be reset to a delinquent status. On the other hand, if the customer does meet the criteria, the delinquent account may be adjusted to a good standing status by the financial account provider.

### CROSS REFERENCE TO RELATED APPLICATION

This application is related to and claims the benefit of priority under 35 U.S.C. 119(e) to U.S. Provisional Patent Application No. 60/329,528, filed on Oct. 17, 2001, the disclosure of which is expressly incorporated herein by reference in its entirety.

### BACKGROUND OF THE INVENTION

I. Field of the Invention

The present invention generally relates to credit card products and, more particularly, relates to systems, methods, and articles of manufacture for managing delinquent financial accounts.

II. Background and Material Information

Credit card products have become so universally well known and ubiquitous that they have fundamentally changed the manner in which financial transactions and dealings are viewed and conducted in society today. Credit card products are most commonly represented by plastic card-like members that are offered and provided to customers through financial account providers, such as banks and other financial institutions. With a credit card, an authorized customer or cardholder is capable of purchasing services and/or merchandise without an immediate, direct exchange of cash. Instead, with each purchase, the cardholder incurs debt to their credit card account, which the cardholder may thereafter pay upon receipt of a periodic account statement. In most cases, the cardholder will have the option to either fully pay the outstanding balance or, as a matter of necessity or choice, defer at least a portion or the balance for later payment. For cardholders electing to defer payment, financial account providers typically assess interest or finance charges for the period during which payment of the outstanding debt is deferred.

Financial account providers must manage accounts issued to their cardholders, including accounts with payments past due. While some cardholders may periodically make payments to reduce their outstanding balance, others cardholders may not even attempt to make a payment and allow their credit card accounts to go into default. Delinquent cardholders or customers can cost financial account providers millions or even billions of dollars in revenue if payment can not be recovered. Furthermore, the financial ramifications on the delinquent cardholder is costly as well. Most financial account providers do not wait a prolonged period for delinquent customers to pay their debt. Instead, to recover all or a portion of the debt, financial entities usually employ various tactics to collect payments from their customers.

Many financial account providers initially make an effort to collect overdue payments using some type of a reminder, such as a letter or a phone call. Initial efforts are usually non-confrontational in instances where there has been a misunderstanding, such as the customer erroneously believing that all debt was previously paid or the financial account provider not receiving payments that actually were sent by the customer. A financial account provider often will receive payments from some customers in response to such a reminder. For other customers, however, this reminder may not be sufficient and their debts will remain unpaid even after the initial non-confrontational reminder(s).

Accounts that remain overdue for a lengthy period of time may be designated as a charged-off account. A charged-off account is an account on which a customer has not made a payment for a predetermined time period. Financial account providers consider charged-off accounts “written off” from their books (e.g., no longer receivable). Financial account providers may continue to attempt collection on charged-off accounts, but customers may no longer use the account to create further debt.

If initial collection efforts fail, some financial account providers resort to using debt collection agencies to collect payments from delinquent customers. For example, a financial account provider may give a number of charged-off accounts to a collection agency, while retaining ownership of the accounts. When customers provide payments to the agency, the agency keeps a percentage (e.g., 50%) and forwards the remainder to the financial account provider. Financial account providers may also try selling a portfolio of charged-off accounts to a collection agency. Under this arrangement, the agency essentially buys the portfolio for a fraction of the debt amount (e.g., less than one cent per dollar) and attempts to collect on the account. Accordingly, a customer then owes the debt collecting agency instead of the original financial account provider. However, the practice of selling portfolios of charged-off debt and managing charged-off accounts is expensive for the financial account provider and may jeopardize relationships with customers.

### SUMMARY OF THE INVENTION

Accordingly, there is a need for an improved methods, systems, and articles of manufacture for facilitating the collection of payments on delinquent financial accounts. There is also a need for a framework to prevent delinquent accounts from becoming charged-off, while at the same time maintaining viable payment options for the customers associated with these delinquent accounts.

Methods, systems, and articles of manufacture consistent with embodiments of the present invention enable a financial account provider to provide a repayment plan to customers who have credit card accounts that are, or soon will be, in a delinquent status. The plan may offer repayment options that the customer may choose to allow them to bring their delinquent account into good standing with the financial account provider by making scheduled and monitored payments.

In one embodiment of the present invention, a financial account provider determines a set of target customers to offer membership into a selected repayment plan. The financial account provider may extend offers to these target customers using a variety of communication channels. For each of the approved target customers that accepts the offer, the financial account provider may allow the customer to select a specific option that may be associated with the repayment plan. For example, in one configuration, the customer may select one of several options that vary in payment schedules, transaction fees and/or time periods. Once an option selection is received from a customer, the financial account provider may adjust the customer's credit card accounts to allow the customer to have the versatility to make the agreed payments that were specified in the selected option without solicitation or reminders from the financial account provider.

Methods, systems, and articles of manufacture consistent with certain embodiments of the present invention allow financial account providers to monitor the progress of customers included in the repayment plan to for compliance with designated criteria for their selected option. In the event a customer meets the criteria after a predetermined period of time, the customer may be rewarded with adjustments to their credit card account and/or external modifications as well, such as adjustments to their credit bureau report.

It is to be understood that both the foregoing general description and the following detailed description are exemplary and explanatory only and are not restrictive of the invention, as described. Further features and/or variations may be provided in addition to those set forth herein. For example, embodiments of the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment, consistent with embodiments of the present invention

FIG. 2 is a flowchart of an exemplary method for offering target customers membership into a repayment plan, consistent with an embodiment of the present invention;

FIG. 3 is a flowchart of an exemplary method for processing responses from a target customer, consistent with an embodiment of the present invention; and

FIG. 4 is a flowchart of an exemplary monitoring method, consistent with an embodiment of the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

Embodiments of the present invention are directed to methods, systems, and articles of manufacture for providing delinquent credit card customers an opportunity to gain membership into a repayment plan offered by a financial account provider. The repayment plan may allow a customer to select certain repayment plan options managed by the financial account provider that include various parameters, such as certain payment amounts, certain time periods, and fees assessed to the delinquent account while the customer is a member of the plan. The financial account provider may monitor each customer's performance while they are a member of the repayment plan to determine whether a customer has failed to meet the criteria associated with the selected option. If a customer fails to meet the criteria, they may be removed from membership in the repayment plan, and the delinquent account may be processed as a standard delinquent account. On the other hand, if a customer meets the criteria during the predetermined time period, the financial account provider may provide benefits to the customer, such as removing the delinquent status assigned to their account, modifying their credit bureau report, and/or offering adjustments to selected terms of their credit account.

Embodiments of the present invention may be implemented in various environments. Such environments and related applications may be specially constructed for performing the various processes and operations of embodiments of the invention or they may include a general purpose computer or computing platform selectively activated or reconfigured by program code to provide the necessary functionality. The exemplary methods disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on embodiments of the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

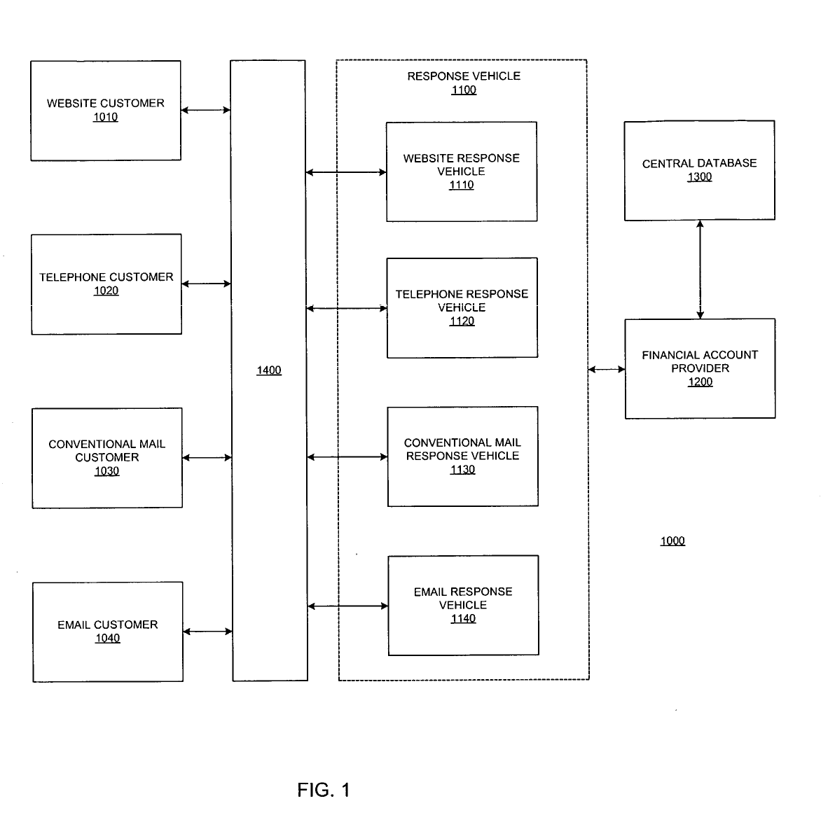

FIG. 1 illustrates an exemplary system environment 1000 in which certain embodiments of the invention may be implemented. As illustrated in FIG. 1, the system environment 1000 includes a plurality of customers (1010-1040), a response vehicle system 1100 including a plurality of different response vehicles (1110-1140), a financial account provider 1200, a central database 1300, and a communications channel 1400.

Each customer in system environment 1000 may be associated with a different customer category. For instance, customer 1010 may be a Web site customer that accesses and retrieves information through a Web site on the World Wide Web of the Internet. The Web site may be a branded Web site operated by one or more vendors, or may be a Web site operated by a financial account provider. Customer 1020 may be a telephone customer that accesses and receives information using conventional telephonic communication techniques and systems. This includes, for example, wireline and wireless telephony systems. Customer 1030 may be a conventional mail customer that accesses and receives information by conventional mail techniques and services. This includes, for example, a customer that is part of a financial account provider's mailing list. Finally, customer 1040 may be a customer that accesses and receives information using electronic mail services. Customer 1010-1040 may also represent entities (such as an individual, a group of individuals, corporate entities, or any combination thereof) that hold credit card accounts with the financial account provider 1200. The categories of customers illustrated in FIG. 1 are exemplary and should not be considered limiting. For example, a variety of different customer categories may also be implemented in environment 1000, such as customers using kiosk computers, personal digital assistants (PDAs), mobile phones, etc..

Response vehicle 1100 represents a system for handling communications between the customers 1010-1040 and financial account provider 1200. Response vehicle 1100 may be part of a financial account provider's network and, as shown in FIG. 1, include a plurality of response vehicles 1110-1140 that correspond to different categories of customers 1010-1040. Each response vehicle is responsible for handling communications to and from customers based on the customers' category. For example, telephone response vehicle 1120 handles telephonic communications between the customer 1020 and financial account provider 1200. Thus, in the event financial account provider 1200 wishes to solicit customers telephonically, response vehicle 1120 includes the necessary systems to support such operations including, for example, operators and telecommunications equipment to communicate with customers 1020. Response vehicle 1130, on the other hand, includes the necessary systems and organizations to handle conventional mail processing to and from customers 1030. Response vehicle system 1140 includes the necessary systems and organizations to process electronic mail transactions with customers 1040. Response vehicle system 1100 may receive responses from the customers and forward them to financial account provider 1200 for appropriate processing. Notifications to the customers also are performed from issuer 1200 to the customer through response vehicle 1100. The notifications may include, for example, messages indicating acceptance into a repayment plan offered by financial account provider 1200.

Communication channel 1400 facilitates communications between the various customers and response vehicle system 1100 illustrated in FIG. 1. Such communications may include communications related to offering and issuing lines of credit to selected customers. Communications channel 1400 may include, for example, a conventional mail distribution network such as that provided by the U.S. Postal Service, a telephony-based network, a local area network (LAN), a wide area network (WAN), a dedicated intranet, the Internet, and/or a wireless network. Further, any suitable combination of wired and/or wireless components and systems may be incorporated into communications channel 1400. Any suitable combination of point-to-point communications or networked communications may also be incorporated into communication channel 1400 to facilitate communication between the different entities illustrated in FIG. 1. Moreover, any part of communication channel 1400 may implemented through traditional infrastructures or channels of trade, to permit operations associated with credit card offers to be performed manually or in-person by the various entities illustrated in FIG. 1.

Financial account provider 1200 receives communication information from response vehicle system 1100 and processes it using central database 1300. Database 1300 may contain various information including credit information, potential customer lists, risk scores for potential and current customers, approved customers, credit limits for approved customers, vendor tables including merchant identification numbers, customer information, purchase information, authorization information, and/or settlement information. Issuer 1200 also sends information to response vehicle system 1100 for delivery to the appropriate customers. Financial account provider 1200 is responsible for providing various credit cards and establishing associated accounts. Financial account provider 1200 may include one or more of the following: a bank, an acquiring bank, a merchant bank, a merchant or any commercial institution capable of providing a financial account, such as a credit card account, consistent with the exemplary embodiments and features disclosed herein. Further, although FIG. 1 only illustrates one financial account provider 1200, it is of course possible that more than one financial account provider be provided in system environment 1000.

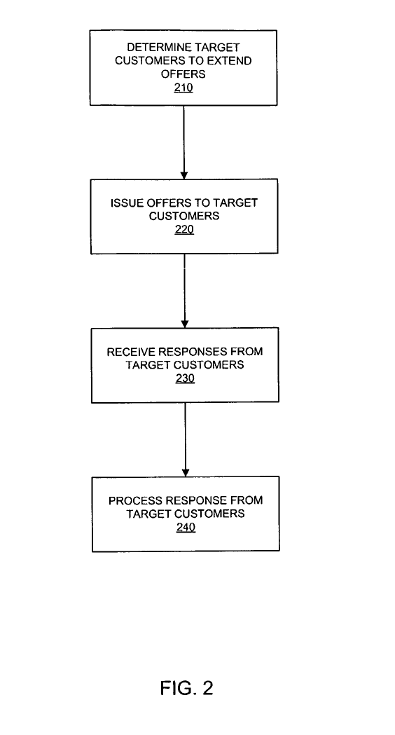

FIG. 2 illustrates an exemplary process associated with providing offers to target customers for membership into a repayment plan, consistent with an embodiment of the present invention. As illustrated on FIG. 2, financial account provider 1200 may identify specific target customers to receive a repayment plan membership offer (Step 210). To identify target customers, financial account provider 1200 may consider several factors. Such factors may be based on the status of a customer's account. For example, financial account provider 1200 may extend offers to customers whose credit card accounts are in a delinquent status or on track to becoming delinquent. A delinquent status may reflect a condition where a customer has failed to make timely payments (or no payments) during a predetermined period of time, such as 120 days. Financial account provider 1200 may determine the conditions required for a credit card account to be transformed into delinquent status. One skilled in the art can realize that a number of different conditions may be considered by financial account provider 1200 without departing from the scope and embodiments of the present invention. For example, in one configuration, financial account provider 1200 may determine the probability of a customer becoming delinquent based on previous payment and transaction history information associated with the customer's credit card account.

Once card issuer 1200 has identified a target group of customers, it may generate an offer for each targeted customer to become a member in a repayment plan. All of the targeted customers may receive the same repayment plan offer, or each customer may receive a personalized offer based specifically on selected conditions associated with the customer's account.

Once the offers are generated, they are sent to response vehicle system 1100 for distribution to the customers (Step 220). Each response vehicle in vehicle 1100 processes the offers in order to provide them to the customers through communication channel 1400. For instance, response vehicle 1110 formulates offers for generation and viewing on one or more Web sites. The Web sites may be associated with a card issuer's Web site or sites that are operated by selected vendors. Once each response vehicle has processed the offers, they are sent to the specified customers for response. Customers 1010-1040 may respond (accept or decline) to the repayment plan offers using the same medium or channel associated with their category, or use a different communication medium. All of the responses from customers are received by response vehicle system 1100 (Step 230), where they are presented to card issuer 1200 for processing (Step 240).

Based on the category of a customer, responses may or may not be processed immediately. For instance, responses may be received and processed instantaneously and/or automatically for customers 1010 and 1020, while responses from customers 1030 may be delayed. For example, suppose a customer 1010 using a personal computer views a Web site operated by issuer 1200. The site may include a designated page that presents the customer with the repayment plan membership determined by issuer 1200. The customer may decide to accept or decline the offer by merely selecting an icon representing their choice and perhaps providing credit information through the Web site. The response is then sent back to response vehicle 1110. Response vehicle 1110 processes the response and prepares it for presentation to card issuer 1200. The response is processed at card issuer 1200 and a notification may be sent back to customer 1010 through response vehicle 1110. The notification may indicate to the customer that their response to an offer has been processed and their membership into the repayment plan. The notifications may be displayed through a Web page that the customer was viewing when the offer was presented or on a separate Web page.

As can be seen, a customer who has accepted an offer through a Web site may receive immediate notification of an approval for a repayment plan provided by credit card provider 1200. On the other hand, a customer who has been solicited by conventional mail, such as customer 1030, may respond to the offer by mailing back an acceptance form to the card issuer. The acceptance form may be received and processed by response vehicle 1130, and eventually processed by financial account provider 1200. Notification of an acceptance by financial account provider 1200 may then be sent back to the customer using the same conventional mail process.

There may be a plurality of variations available to card issuer 1200 when communicating with customers. That is, a mail customer 1030 may wish to respond by telephone or through a Web site. Additionally, customers may respond by one medium, and request notification by another. For instance, a customer 1030 who has received an offer in the mail, may respond by mail, yet request notification by email. Accordingly, a variety of user friendly options are available to customers for receiving and responding to the offers presented by card issuer 1200. The above descriptions are for illustration purposes alone and should not be viewed as limitations to embodiments of the present invention. One of ordinary skill in the art can realize that any number of combinations of communication techniques may be implemented without departing from the embodiment of the present invention.

In one embodiment of the present invention, the offers for membership into the repayment plan may include options that the customer may select to repay any past due amounts to financial account provider 1200. For example, a customer may choose between several repayment options that includes various parameters, such as payment amounts, payment time periods, interest rates, and fees. Below is an exemplary listing of three repayment options available to the target customers that may allow them to provide payments that are past due to financial account provider 1200. The particular plan(s) for a customer may be selected based on one or more conditions, or a function of the financial information, associated with the customer and his/her account with financial account provider 1200.

Option 1

1. First payment of 50% of the past due amount due immediately; and

2. Second payment of 50% of the past due amount due by a predetermined time period, such as 30 days.

In the case of OPTION 1, the customer may not be charged any fees or interest on the past due amounts during the time period the customer is a member of this repayment option.

Option 2

1. First payment of 65% of past due amount due in 14 days;

2. Second payment of 17.5% of past due amount due within 30 days following the due date associated with the first payment; and

3. Third payment of 17.5% of past due amount within the next 30 days following the due date associated with the second payment.

Under OPTION 2, the customer may be charged a determined fee and an interest rate on the past due amounts during the time period the customer is a member of this repayment option.

Option 3

1. First payment of 34% of past due amount due in 14 days;

2. Second payment of 33% of past due amount due within 30 days following the due date associated with the first payment; and

3. Third payment of 33% of past due amount within the next 30 days following the due date associated with the second payment.

With OPTION 3, the customer may be charged two determined fees and an interest rate on the past due amounts during the time period the customer is a member of this repayment option. The interest rate in this option may be higher than the interest rate charged in OPTION 2.

For each repayment option, a payment amount past due may be associated with a number of different of financial situations, such as an overlimit amount (e.g., amount the customer is above a credit limit) or a past due amount based on previous requested payment amounts that may or may not include penalty fees. In one embodiment, financial account provider 1200 determines the overlimit or past due amount that, when paid, allows the customer's delinquent status to be changed to a good standing status. Financial account provider 1200 may determine which of the two amounts is greater (e.g., past due amount or overlimit amount) and designate the greater amount as the total payment amount that the customer is required to pay off while a member of the repayment plan.

Based on the total payment amount, one or more conditions (e.g., repayment parameter) for repayment may be determined by provider 1200 (e.g., number payments, amounts of each payment, etc.). For example, consider a financial account associated with a $100 overlimit amount and a $50 past due amount. Financial account provider 1200 may determine that the total payoff amount for a selected repayment option is $100, based on the overlimit amount for the exemplary account. Further, provider 1200 may ensure that the amount of a first payment for a repayment plan option is large enough to cover the current past due amount (e.g., previous past due amounts and any minimum payments that are currently due). Alternatively, if the past due amount is greater than the overlimit amount (e.g., overlimit is $50 and past due amount is $100), provider 1200 may determine the amount of a first payment for a repayment option is large enough to cover the overlimit amount.

In another embodiment, financial account provider 1200 may facilitate negotiations with a customer to create a repayment option that reduces or eliminates one or more fees charged to the customer's financial account. For example, a representative associated with financial account provider 1200 may offer a customer one or more alternative options that are not included in an original offer provided to the customer. The customer and representative may engage in negotiations that present the customer with an option having one or more conditions that a customer is able to meet, such as a reduced first payment amount. Alternatively, financial account provider 1200 may automatically perform negotiations with a customer. For example, a customer that receives an offer through a Web page solicitation may be presented with one or more interactive offers that enable the customer to negotiate with provider 1200 to create a customized repayment option with conditions determined by the customer, financial account provider 1200, or both. For instance, provider 1200 may provide a query on a Web page that requests financial information from a customer. The customer may provide a response to the query, such as, for example, a requested first time payment, number of payments, payment amounts, etc.. Based on the customer's response, provider 1200 may present a counter-offer with alternate payment amounts, first time payment, etc., accept the customer's terms included in the response, or reject the customer's terms. One skilled in the art will appreciate that the negotiation process may be facilitated using mediums other than Web-based media, such as automated telephone processes that exchange information over wireline or wireless communication networks.

As a member of the repayment plan, the customer may be required to meet certain criteria. For example, one criteria may be that the customer must make the required payment associated with their selected option within the set time period or the customer is removed from the repayment plan. Also, financial account provider 1200 may provide certain incentives to customers who accept membership into the repayment plan. For example, financial account provider may associate an indicator with the customer's credit card account indicating that the customer is not to receive any phone calls or communications associated with collection activities for the past due amount while the customer is a member of the repayment plan. Also, processing fees that may be assessed to electronic payment transactions over the Internet or telephone that are generally charged to a standard customer (i.e., those not on the repayment plan) may be waived by financial account provider 1200. One skilled in the art can realize that financial account provider may employ various incentives and criteria for the repayment plan and for selected options of the repayment plan, without departing from the embodiments and scope of the invention. Furthermore, the options listed above are not intended to be limiting, and one skilled in the art can realize that other options with varying conditions may be employed with departing from the scope of the present invention.

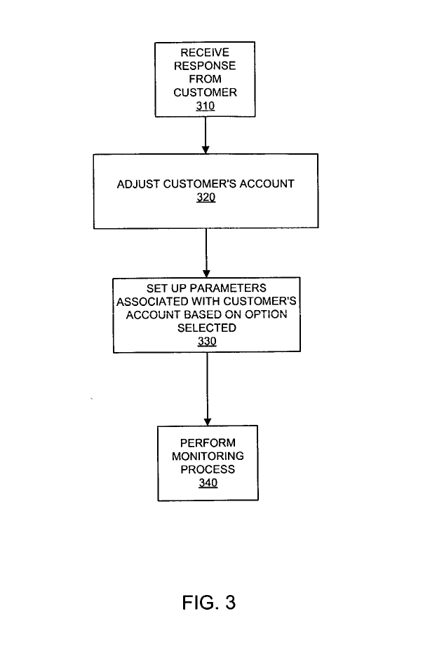

FIG. 3 illustrates an exemplary process that may be performed by financial account provider 1200 when processing a target customer's acceptance of the offers described with respect to FIG. 2. As shown, financial account provider 1200 may receive a response from a target customer indicating their acceptance into the offered repayment plan (Step 310). The response may include a repayment option selected by the customer, such as one of the exemplary options listed above (i.e., OPTIONS 1, 2, and 3). Financial account provider 1200 may be configured to adjust or update the customer's credit card account to indicate membership into a selected repayment plan option (Step 320). For example, in one configuration, an indicator may be set in the customer's account, perhaps stored in central database 1300, that reflects membership into the repayment plan. Additionally, or alternatively, financial account provider 1200 may add the target customer's credit card account into a repayment plan table stored in a memory device. This memory device may be located within central database 1300 or may be located remotely from database 1300. Also, the repayment plan table may be any type of file that stores information accessible by financial account provider 1200, such as a file, array, table, listings, or the like. Furthermore, financial account provider 1200 may set indicators in the customer's account that prevent solicitations for payment collections from credit issuer 1200, either by personnel or as the result of automatically generated messages.

Once the target customer's credit card account is adjusted, financial account provider 1200 may set up parameters for the customer's account based on the option selected by the customer (Step 330). These parameters may include the payment amount, time periods that these payments are due, interest rates, and/or fees that may or may not be assessed to the credit card customer's account while a member of the repayment plan. After these parameters are set up, financial account provider 1200 may perform a monitoring process to monitor the activity of the customer's account while a member of the repayment plan (Step 340).

Consistent with embodiments of the invention, additional features or steps may be provided with the exemplary method of FIG. 3. For instance, after a customer's account has been updated and the appropriate parameters have been set for the selected repayment plan, financial account provider 1200 may send a notification to the customer to confirm enrollment in the repayment plan. Additionally, prior to adjusting a customer's account, financial account provider 1200 may perform an analysis to confirm that the customer is eligible for the requested repayment plan. As part of this analysis, for example, a risk assessment may be performed based on the customer's financial history and/or the status of the customer's credit card account may be checked. By way of example, if the customer's account has been charged-off and/or sold to a collection agency then approval for the repayment plan may be denied. Notification that the repayment plan has been denied may also be provided to the customer.

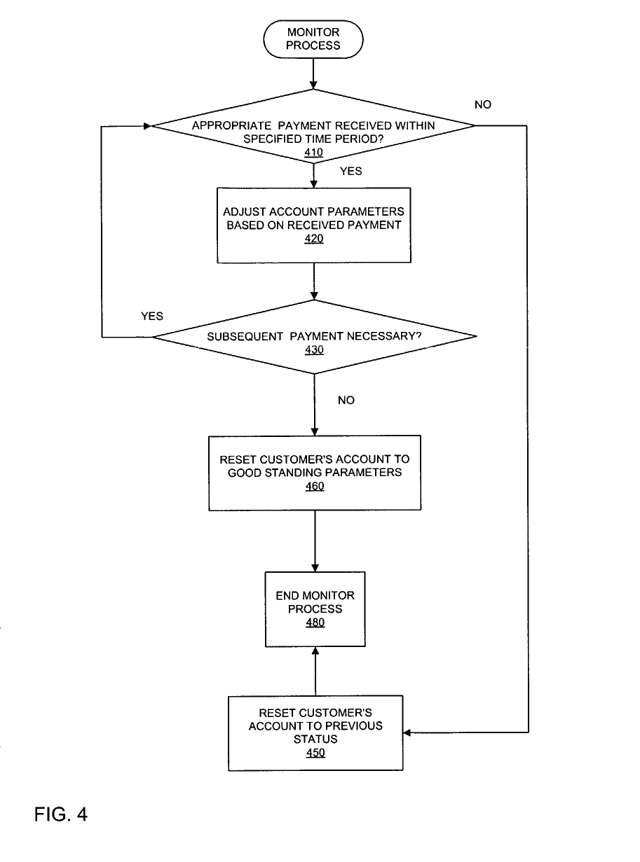

FIG. 4 shows a flowchart of an exemplary monitoring process, consistent with an embodiment of the present invention. The monitoring process may begin by financial account provider 1200 determining whether an appropriate payment for the customer's account is received within a designated time period based on the option the customer selected (Step 410). If not (Step 410; NO), then the customer has failed to meet a criteria set by financial account provider 1200 and the customer's credit card account may be reset to its previous status (Step 450), and the monitor process ends (Step 480). Alternatively, financial account provider 1200 may set the status of the customer's account to a delinquent status in Step 450. One skilled in the art can realize that financial account provider 1200 may be configured to perform various other tasks in the event a customer has failed to meet selected criteria while a member of the repayment plan. For example, a report to a credit bureau may be provided that indicates the customer's delinquent status. Alternatively, the account may be charged-off. Also, the customer's account may be removed from the repayment plan, and the appropriate parameters associated within plan eliminated. Accordingly, many different tasks may be performed by financial account provider 1200 in response to a customer failing to meet the criteria for a selected repayment plan option, without departing from the embodiments and scope of the present invention.

If, however, an appropriate payment is received within the specified time period (Step 410; YES), financial account provider may adjust the customer's account parameters to reflect the received payment (Step 420). Also, based on the option the customer selected, the repayment plan parameters associated with the customer's account may be adjusted. For example, if the customer selected OPTION 2, and made the first payment on time, financial account provider 1200 may adjust the parameters of the customer's account such that the monitor process expects a second payment of 17.5% of the past due amount within 30 days. After adjusting the parameters, financial account provider 1200 may then determine whether a subsequent payment is necessary (Step 430). If so, (Step 430; YES) the monitor process determines whether the next payment has been received within the specified time period (Step 410), and Steps 420 and 430 are repeated until no further payments are necessary.

At Step 460, once the customer has made all of the necessary payments as required under the repayment plan option the customer's account was associated with, financial account provider 1200 may reset the customer's account to good standing parameters (Step 460) and the monitor process ends (Step 480).

In one embodiment of the present invention, good standing status may be associated with credit card accounts which do not have any past due amounts or are not over credit limits. Financial account provider 1200 may also be configured to update a credit bureau report to reflect the customer's good standing. Furthermore, financial account provider 1200 may delete the customer's account from the repayment plan table and reset the parameters of the account to the conditions and terms that were previously offered before the customer became a member of the repayment plan. One skilled in the art can realize that financial account provider 1200 may perform various other tasks associated with customers who successfully completes the repayment plan, including but not limited to, adjusting the customer's credit limit, interest rates, fees, and the like.

As disclosed herein, methods, systems, and articles of manufacture consistent with embodiments of the present invention enable credit card customers who have been late in making, or neglected to make, payments to a financial account provider to reestablish good account standing by entering a repayment plan offered by the financial account provider. Although the present invention has been described based on the system environment 1000 of FIG. 1, one skilled in the art can realize that various other configurations may be employed. Furthermore, the configurations of the repayment plan itself, including the option, parameters, and processing thereof may be adjusted to meet the needs of the financial account provider and its customers, without departing from the spirit and scope of the present invention. For example, a financial account provider may associate a demerit point with a delinquent customer's financial account that participates in a repayment plan. When the delinquent customer completes the repayment plan, the financial account provider may adjust the status of the customer's account to be non-delinquent. In the event the customer's account becomes delinquent again, the financial account provider may allow the customer to participate in the repayment plan again, and in doing so, may associate another demerit point to the customer's account. In this configuration, the financial account provider may limit the number of times the customer may participate in the repayment plan by monitoring the number of demerit points associated with the customer's account. One of ordinary skill in the art can realize that techniques other than demerit points may be used, such as assessing a risk score to the customer's account based on the customer's past payment history, outstanding balance, or other similar financial information.

Further, certain embodiments of the present invention may adjust the status of a financial account based on a number of different characteristics associated with the financial account. For example, in addition to adjusting the status of the financial account based on a financial balance of the account, certain embodiments of the present invention may allow the status to be adjusted based on past use of the account by the customer. For instance, in one embodiment, financial account provider 1200 may adjust the status of a customer's financial account based on whether the customer has not exceeded the credit limit for the account over a predetermined period of time. Alternatively, the account's status may be adjusted based on a determination whether the financial account has not been assessed any type of penalty fee from financial account provider 1200 over the predetermined period of time.

Other embodiments of the invention will be apparent to those skilled in the art from consideration of the specification and practice of the embodiments of the invention disclosed herein. For example, the process steps shown in the embodiments of FIGS. 2-4 are not limited to the sequences described above. Variations of these sequences, such as the removal and/or the addition of other processes may be implemented without departing from the spirit and scope of the present invention.

Additionally, embodiments of the present invention may be applied to financial accounts other than credit card accounts. Any financial institution that provides financial accounts to customers may employ methods, systems, and articles of manufacture consistent with teachings herein. For example, a bank which provides financial loans to customers may have a customer who is delinquent, or about to be delinquent, on payments associated with a loan. The bank may be configured to offer a repayment plan to the customer and monitor the customer's account progress during the plan.

Furthermore, although aspects of the present invention are described as being associated with data stored in memory and other storage mediums, one skilled in the art can appreciate that these aspects can also be stored on or read from other types of computer-readable media, such as: secondary storage devices, like hard disks, floppy disks, or CD-ROM; a carrier wave from the Internet; or other forms of RAM or ROM.

Accordingly, it is intended that the specification and examples be considered as exemplary only, with a true scope and spirit of the invention being indicated by the appended claims in light of their full scope of equivalents.

What is claimed is:

1. A method for managing a financial account, comprising:
identifying a financial account with a delinquent status;
providing a repayment plan offer to a customer associated with the financial account;
receiving a response from the customer including a selection of a repayment option;
monitoring activity associated with the financial account during a predetermined time period based on the repayment option; and
adjusting the status of the financial account based on the activity.

2. The method of claim 1, wherein monitoring activity comprises:
determining whether a predetermined payment is received within a selected time period.

3. The method of claim 1, wherein adjusting the status of the financial account, comprises:
changing the status of the financial account from delinquent to good standing based on a determination that the financial account is current with no past due balance.

4. A method of managing a financial account, comprising:
providing an offer to a customer associated with a financial account that has a payment amount that is past due, wherein the offer includes a plurality of options including various repayment parameters;
receiving a response from the customer indicating a selection of one of the plurality of options;
associating the financial account with a repayment plan for a predetermined period of time based on the selected option; and
determining whether a payment is received that meets the repayment parameters included with the selected option during the predetermined period of time.

5. The method of claim 4, wherein the repayment parameters included with the selected option includes at least one of a predetermined payment amount and a selected time period from which the predetermined payment amount is due.

6. The method of claim 4, further comprising:
adjusting a status of the financial account when it is determined that a financial account provider has received one or more payments that substantially equal the payment amount that is past due.

7. The method of claim 4, further comprising:
adjusting a status of the financial account when it is determined that a financial account provider has received one or more payments that substantially equal the payment amount that is past due and one or more fees charged to the financial account.

8. The method of claim 7, wherein the one or more fees is charged to the financial account based on the option selected by the customer.

9. A method of managing a financial account, comprising:
providing an offer to a customer associated with a financial account that has a payment amount past due to a financial account provider;
receiving a response from the customer indicating an acceptance of the offer;
associating the financial account with a repayment parameter in response to the acceptance; and
determining whether a payment is received that meets the repayment parameter within a predetermined period of time.

10. The method of claim 9, wherein the repayment parameter includes a predetermined payment amount.

11. The method of claim 9, further comprising:
adjusting a status of the financial account when it is determined that the financial account provider has received one or more payments that substantially equal the payment amount that is past due.

12. The method of claim 9, further comprising:
adjusting a status of the financial account when it is determined that the financial account provider has received one or more payments that substantially equal the payment amount that is past due and one or more fees charged to the financial account.

13. A system for managing a financial account, comprising:
a processor; and
a memory including program instructions for causing the processor to:
offer repayment options to a customer associated with a delinquent credit card account,
receive a response from the customer reflecting a selection of one of the repayment options, and
monitor payment activity of the delinquent credit card account based on parameters associated with the selected repayment option.

14. The system of claim 13, wherein the memory further includes program instructions for causing the processor to:
provide the repayment options to the customer based on financial information associated with the delinquent credit card account.

15. The system of claim 13, wherein the memory further includes program instructions for causing the processor to:
provide the repayment options to the customer based on financial information associated with the customer.

16. A system for managing a financial account, comprising:
a processor; and
a memory including program instructions for causing the processor to:
offer a repayment plan to a customer associated with a delinquent credit card account,
receive a response from the customer reflecting an acceptance of the offer, and
monitor payment activity of the delinquent credit card account based on one or more parameters associated with the repayment plan.

17. The system of claim 16, wherein the memory further includes program instructions for causing the processor to:
provide the offer to the customer based on financial information associated with the delinquent credit card account.

18. The system of claim 16, wherein the memory further includes program instructions for causing the processor to:
provide the offer to the customer based on financial information associated with the customer.

19. The method of claim 3, further comprising:
providing a subsequent repayment plan offer to the customer when the status of the financial account changes from a good standing status to a delinquent status;
monitoring activity associated with the financial account during a second predetermined time period based on a second response from the customer reflecting a selection of another repayment option; and
adjusting the status of financial account from a delinquent status to a good standing status based on the activity monitored during the second predetermined time period.

20. The method of claim 19, wherein the customer does not receive further repayment plan offers when the status of the financial account changes from a delinquent status to a good standing status a predetermined number of times.

21. The method of claim 1, wherein providing a repayment plan offer to a customer further includes:
performing negotiations with the customer to determine one or more conditions for a repayment plan.

22. The method of claim 4, wherein providing a payment plan offer to a customer further includes:
performing negotiations with the customer to determine one or more conditions for the each of the plurality of options.

23. The method of claim 9, wherein providing an offer to a customer further includes:
performing negotiations with the customer to determine one or more conditions for the offer.

24. A computer-readable medium including instructions for performing a method, when executed by a processor, for managing a financial account, the method comprising:
providing an offer to a customer associated with a financial account that has a payment amount that is past due to a financial account provider, wherein the offer includes a plurality of options including various repayment parameters;
receiving a response from the customer indicating a selection of one of the plurality of options;
associating the financial account with a repayment plan for a predetermined period of time based on the selected option; and
determining whether a payment is received that meets the repayment parameters included with the selected option during the predetermined period of time.

25. The computer-readable medium of claim 24, wherein the repayment parameters included with the selected option includes at least one of a predetermined payment amount and a selected time period from which the predetermined payment amount is due.

26. The computer-readable medium of claim 24, wherein the method further comprises:
adjusting a status of the financial account when it is determined that the financial account provider has received one or more payments that substantially equal the payment amount that is past due.

27. The computer-readable medium of claim 24, wherein the method further comprises:
adjusting a status of the financial account when it is determined that the financial account provider has received one or more payments that substantially equal the payment amount that is past due and one or more fees charged to the financial account.

28. The computer-readable medium of claim 27, wherein the one or more fees is charged to the financial account based on the option selected by the customer.

29. A computer-readable medium including instructions for performing a method, when executed by a processor, for managing a financial account, the method comprising:
providing an offer to a customer associated with a financial account that has a payment amount that is past due to a financial account provider;
receiving a response from the customer indicating an acceptance of the offer;
associating the financial account with a repayment parameter in response to the acceptance; and
determining whether a payment is received that meets the repayment parameter within a predetermined period of time.

30. The computer-readable medium of claim 29, wherein the repayment parameter includes a predetermined payment amount.

31. The computer-readable medium of claim 29, wherein the method further comprises:
adjusting a status of the financial account when it is determined that the financial account provider has received one or more payments that substantially equal the payment amount that is past due.

32. The computer-readable medium of claim 29, wherein the method further comprises:
adjusting a status of the financial account when it is determined that the financial account provider has received one or more payments that substantially equal the payment amount that is past due and one or more fees charged to the financial account.
